(19) United States
(12) Patent Application Publication
(10) Pub. No.: US 2016/0240273 A1
(43) Pub. Date: Aug. 18, 2016

(54) HYBRID NUCLEAR-HYDRO POWER PLANT

(71) Applicant: Robin Jerry McDaniel, Lake Villa, IL (US)

(72) Inventor: Robin Jerry McDaniel, Lake Villa, IL (US)

(21) Appl. No.: 14/622,844

(22) Filed: Feb. 14, 2015

(51) Int. Cl. G21D 1/04

(52) U.S. Cl. CPC G21D 1/04

(57) ABSTRACT

An improved electrical generation system explained herein is a method and equipment whereby nuclear reactors are used to directly propel water pumps to lift water from a lower-elevation body of water to a higher-elevation body of water, where it is stored as potential energy.

In one application of this method, one or more water pumps, each powered directly by heat from a nuclear reactor, lift water from down-stream of a river, stream, or pond to upstream of a dam at which a hydro-power plant is installed. The nuclear reactor may be of the pressurized-water, boiling-water, liquid metal cooled, or molten salt-cooled type. Small modular reactors (SMRs) are ideally suited to provide pumping heat in an incremental manner in such a method. Reactor heat output may be proportionally diverted to pumping or desalination loads to maintain the reactor core power level at a constant optimized steady state. Upon demand, the lifted water is used to generate electricity utilizing the hydro-power plant. A weir or small dam may be constructed across the river or stream downstream of the heat powered pump, the function of which is to create a reservoir or pool from which water can be pumped.

This way, water can be recycled and used more than once to generate electricity, and the reactor can be operated at a steady state power level in conjunction with a preexisting hydro-power plant, thus allowing generation of electricity year-round despite lower water flow conditions.

### FEDERALLY SPONSORED RESEARCH

Not Applicable

### SEQUENCE LISTING OR PROGRAM

Not Applicable

### BACKGROUND AND FIELD OF THE INVENTION

This invention relates to electrical power generation in general, and more specifically describes a method and apparatus for economically converting nuclear energy (heat) into water potential energy by utilizing nuclear reactors coupled directly with water pumps to lift water from downstream to upstream of hydro-power plant. Upon demand, the stored water is used to generate electricity by the hydroelectric power plant. This way, water can be recycled and used more than once to generate electricity, and the reactor can be operated at a steady state power level.

### BACKGROUND DESCRIPTION OF PRIOR ART

References
U.S. Patent Documents

| | | | |
|---|---|---|---|
| 4,177,019 | 1978 | Chadwick | 417/379 |
| 4,166,222 | 1979 | Hanley | 290/55 |
| 6,023,105 | Feb. 8, 2000 | Youssef | 290/54 |
| 6,073,445 | Jun. 13, 2000 | Johnson | 60/512 |

Hydro energy has been used in different parts of the world for centuries before the birth of Christ, and since the late 19^{th} century to generate electricity by utilizing the potential energy of an elevated body of water.

In the context of hydro-power plant operations, a major concern is the availability of a consistent supply of reservoir water to run the turbo generators. Many such dams are underutilized with seasonal variation as inflow deficit limits the availability of water as potential energy. Recent analytical modeling of water availability and prediction of other water usages are a complex and developing science.

One approach to the problem of storing energy and then utilizing the stored energy as electricity is by pumped-storage systems. These are typically designed to utilize a combination generator-motor to pump the water from a lower reservoir to an upper reservoir by drawing electricity from the grid during low electricity demand periods then reversing the function of the pumps to act as generators to convert the potential energy of the upper reservoir into electricity at higher demand periods. This energy can come from a variety of electrical sources, including other hydro-electric stations, fossil fueled generators, wind, or even conventional nuclear power generators.

Many problems associated with the current methods of creating energy to lift water in such systems exist. The electricity used to lift the stored water may or may not be locally generated or may not be naturally dependable or reliable as in the case of solar or wind power. If a conventional nuclear power plant is utilized, the energy has been converted from nuclear heat into steam, then into mechanical motion with turbines, then generating electricity. As the efficiency in each step is less than unity, therefor the multiplication of all the conversion factors leads to unavoidable losses.

Some previous inventions include heat sources that utilize combustion of fossil fuels, yet the main problem with that approach is the production of combustion gasses including large amounts of carbon dioxide and other pollutants.

If a utility wishes to build a new nuclear power plant, and pump water utilizing an electric-powered pump into a storage reservoir, such conventional nuclear power plants not only include the reactor heat source, but also the “Balance of Plant” required to generate electricity. This overly complicates the design, licensing, and operations of such power plants, and does not avoid the multiple step conversion power losses.

### SUMMARY OF THE INVENTION

The present invention is specified in view of the aforesaid problems in the related art.

With the introduction of this visionary concept, the existing investment in the hydro-power plant can be maximized without the need to balance the various demands on precious water resources.

Tail water recycling via a collection pond or reservoir with pumps directly connected to a nuclear reactor eliminates many of these concerns. The envisioned simplified nuclear reactor system need not generate electricity as do conventional nuclear power plants, yet the heat from the reactor may be directly utilized to generate pumping power to lift water. Additional benefits from such a system are that the reactor need not follow the electricity loads or demands, as the source of energy is decoupled from the generation of electricity by the large potential energy capacity of the reservoir. This allows for much simplified design, licensing, and ease of operating the reactor in a steady state mode.

Intrinsically safe nuclear reactors (ISNR) and intrinsically safe small modular reactors differ from conventional nuclear fission reactors in that the design is more elegantly simple affording lower costs and ease of operation. A Bi-Stable reactor would be ideal for this application.

In one application of this invention, one or more water pumps, each powered directly by heat from a nuclear reactor, lift water from down-stream of a river, stream, or pond to upstream of a dam at which a hydro-power plant is installed. Intrinsically safe small modular reactors are ideally suited to provide pumping heat in an incremental manner in such an application. Upon demand, the lifted water is again used to generate electricity by the hydro-power plant. A weir or small dam may be constructed across the river or stream downstream of the heat-powered pump, to create a reservoir or pool from which the water can be drawn and recycled.

### Past Disclosure of Concept:

Also disclosed is a method for incorporating an intrinsically safe nuclear fission reactor in a pumped storage system that comprises: (a) specifying an initial reactor design with a pumping unit and desalination unit; (b) specifying an energy storage reservoir and (c) a hydro-electric plant, thus creating a “Hybrid Nuclear Power System” (see System Flow Chart, FIG. 4, of Application number 20110255650)

Combinations of multiple intrinsically safe nuclear reactors, pumping units, and conventional hydro-electric power stations all utilizing a common large energy storage reservoir, comprise a “Hybrid Nuclear Power System” is also disclosed and claimed.

From March 2010

FIG. 4 is a diagram of the components, one of which is the intrinsically safe reactor, in relation to other major components utilized to generate electricity, desalinate seawater, or provide district heat, in a “Hybrid Nuclear Power System”, according to the teachings of the present invention.

### BRIEF DESCRIPTION OF THE DRAWINGS

Illustrative and present embodiments of the invention are shown in the accompanying drawings in which:

FIG. 1 “Overview of Invention”, is an elevation view of a representation showing the components of a Hybrid Nuclear-Hydro Power Plant according to one embodiment of the present invention;

FIG. 2 “Heat-Powered Pump”, is a sectional view of a heat-powered pumping chamber of said system showing the two cycles of operation: filling and lifting, according to one embodiment of the present invention.

### REFERENCE NUMERALS USED IN DRAWINGS

A Nuclear Reactor as Heat Source
B Heat Powered Pump
C Dam with High Reservoir
D Hydro-Electric Generation Facility
E Low Reservoir
1 High Heat Supply Conduit
2 Waste Heat Return Conduit
3 Reverse Penstock
4 Dam
5 Penstock
6 Hydro-Electric Power Station
7 Discharge Tailpipe
8 Water Inlet
9 Watersource, Sea or Aquifer
10 Salt Water Input
11 Cooling Conduit
12 Fresh Water Conduit
13 Brine Water Output
21 Pumping Chamber Wall
22 Chamber Cover, Valve, Equipment, and Conduit Support Ring
23 Discharge Check Valve Assembly
24 Inlet Check Valve Assembly
25 Vaporizer Assembly
26 Discharge Pipe
27 Vapor Exit Valve and Conduit
28 Working Fluid Supply and Return Conduits

However, before proceeding with the description, it should be noted that the various embodiments shown and described herein are exemplary only and are not intended to represent the extent to which the present invention may be utilized. Indeed, the systems and methods described herein could be readily applied to any of a wide range of Hybrid Nuclear-Hydro Power System designs, as would be obvious to persons having ordinary skill in the art after having become familiar with the teachings provided herein. Consequently, the present invention should not be regarded as limited to the particular Hybrid Nuclear-Hydro Power System and example configurations shown and described herein.

### DETAILED DESCRIPTION

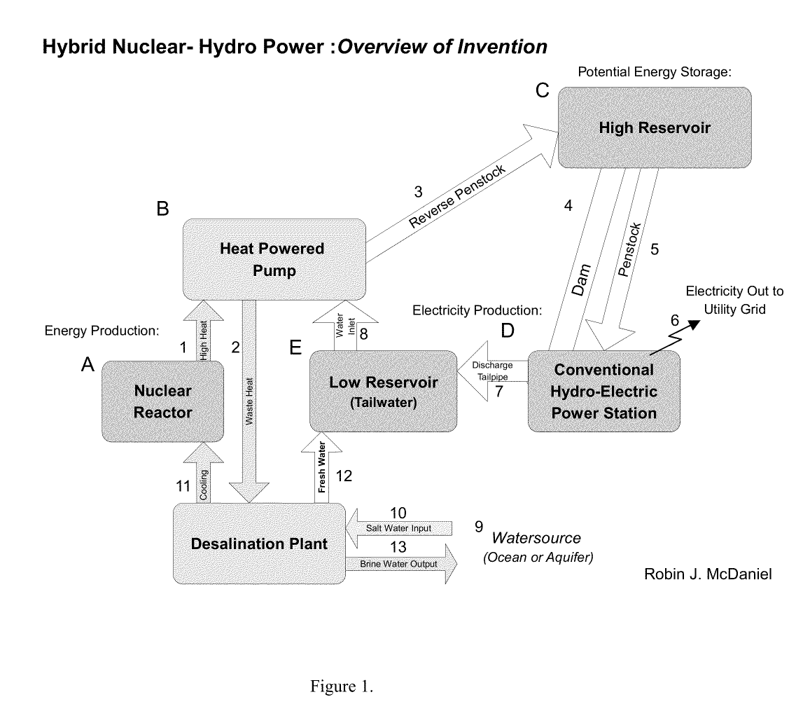

Referring now to FIG. 1: “Overview of Invention”, one embodiment of an Hybrid Nuclear-Hydro Power Plant may comprise a Nuclear Reactor A to provide heat to a Heat-Powered Pump B which takes water from a Low Reservoir E and lifts the water to a High Reservoir C where a Hydro-Electric Power Station D uses the potential energy of the reservoir to generate electricity. In one embodiment of a Hybrid Nuclear-Hydro Power Plant may utilize the waste heat from the Heat-Powered Pump B to provide low-value heat to a Desalination Plant, thus returning the coolant back to the Nuclear Reactor A after making fresh water, which may be deposited into the Low Reservoir E or otherwise distributed.

When the Nuclear Reactor A is turned on, and sufficient heat is achieved, a conduit 1 conveys the high value heat to a Heat Powered Pump B, which utilized inlet water 8 from the Low Reservoir E, via a created difference in pressure, lifting the water through a Reverse Penstock 3 into the High Reservoir C to be stored as potential energy.

When required, a Hydro-Electric Power Station D removes the water via a Penstock 5 from the High Reservoir C supported by a Dam 4, and converts the potential energy stored in the elevated water to kinetic energy via gravitational acceleration to generate electricity 6 output to the Utility Grid or other electrical loads.

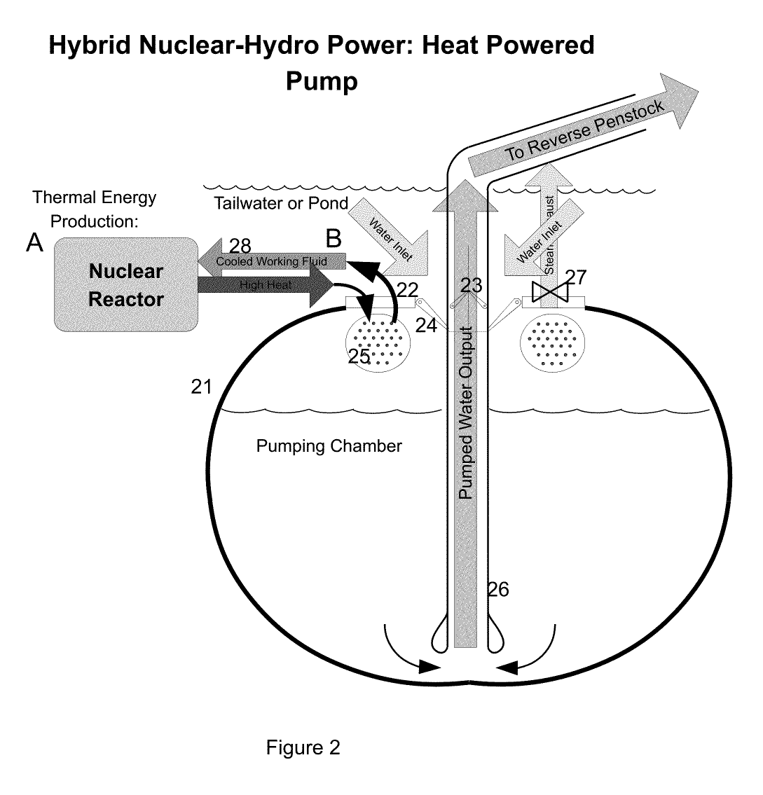

Referring now to FIG. 2: “Heat-Powered Pump”, one embodiment of an Hybrid Nuclear-Hydro Power Plant may comprise a Heat-Powered Pump B which takes water from a Low Reservoir via a water inlet where the water flows via gravity from the pond or tailwater downstream of the hydro-electric plant discharge.

In one embodiment of such a pump, the pump comprises a Pumping Chamber Wall 21 wherein the water to be lifted falls through an Inlet Check Valve Assembly 24 until the pumping chamber is filled. During the filling cycle of operation the inlet water level is rising and the previous vapor (steam) is being released through a plurality of Vapor Exit Valves and Conduits 27 which may pass through another machine(s) or turbine(s) to recover additional energy from the steam (not depicted yet known to those practitioners of the art). As the water rises to maximum level the Inlet Check Valves close and then a set of energy transfer devices, in one embodiment, comprises a generally toroidal-shaped set of coils, a Vaporizer Assembly 25 in which the high value heat from the Nuclear Reactor A has passed from the reactor into the pump via a plurality of Working Fluid Supply and Return Conduits 28 and transfers the heat via radiation and conduction into the water. In one embodiment, the water floods the Vaporizer Assembly 25, and when a sufficient amount of heat has transferred into the water, the sensible heat rises and then latent heat is absorbed to vaporize the water creating steam. Depending upon the design requirements for volume and pressure to lift the water, a variety of sizes and volumes of components of the Vaporizer Assembly 25 are envisioned. As the pressure rises in the pumping chamber the water level remains constant until the design pressure has been achieved. At that time the lifting force opens the Discharge Check Valve Assembly 23 and allows for the water to pass upwards through the Discharge Pipe, with an “Entry Flow Enhancing Shape” 26, out of the pumping chamber past the Chamber Cover, Valve, Equipment, and Conduit Support Ring 23 and exits into the Reverse Penstock, flowing up towards the High Reservoir.

When the discharge cycle has completed the pressure in the pumping chamber lowers, and when it is less than the pressure inside the Discharge Pipe 26 the Discharge Check Valve 23 closes and the flow stops. The control system (not depicted, yet known to practitioners in the art) opens the Vapor Exit Valve(s) 27 and allows the pressurized steam to exit through the exit conduit, and lowers the pressure inside the pumping chamber, thus allowing the filling cycle to begin again.

In one embodiment of the invention, a plurality of Heat Powered Pumps work out of phase with each other to provide a more or less constant flow of water into the High Reservoir, and provide a more or less consistent demand on the Nuclear Reactor heat source by lifting the water to the High Reservoir via a manifold discharge into the Reverse Penstock to be stored as potential energy.

As a component of a “Hybrid Nuclear-Hydro Power System”, the Intrinsically Safe Nuclear Reactor, (ISNR), may provide high value, high temperature heat to another energy conversion component (water/steam/water or other vapor cycle thermal to mechanical energy system, or process load; which converts the high value heat output from the Intermediate Heat Exchanger (IHX) portion of the reactor, to a conventional or legacy electric plant to create electricity and distribute it to the community, and waste heat from the energy conversion component may also utilize low value heat to provide district heating and cooling, and to desalinate seawater or purify other watersources.

Additionally, as the total “Hybrid Nuclear-Hydro Power System” is modular in nature, multiple reactors or heat sources could provide heat energy to multiple Heat Powered Pump units that could utilize the same reservoir with multiple reactor-pumps and hydro-electric plants to increase overall performance and operational redundancy of the total system. An additional embodiment of this invention is for use with cascading water reservoirs, each with smaller hydro-power electrical generators for local use.

In another embodiment of the invention, nuclear reactor heat powered steam turbine(s) coupled to conventional mechanical or centrifugal pumps may be utilized as part of a Hybrid Nuclear-Hydro Power System.

In summation, then, because persons having ordinary skill in the art could readily select from one or several component configurations of the design described herein, after having become familiar with the teachings of the present invention, the present invention should not be regarded as limited to varying any one or combination of the heat sources, pumping units, process heat loads, or hydro-power components described herein.

Present invention should not be regarded as limited to any kind of working heating fluid.

Present invention should not be regarded as limited to any kind of reservoir storage fluid.

Present invention should not be regarded as limited to any scale of power output.

Present invention should not be regarded as limited to any scale of energy storage.

Present invention should not be regarded as limited to any particular type of renewable heat source or combination of heat sources.

Having herein set forth some embodiments of the present invention, it is anticipated that suitable modifications can be made thereto which will nonetheless remain within the scope of the invention. The invention shall therefore only be construed in accordance with the specific included claims.

I claim the invention is:

1. A hybrid nuclear-hydro power plant in which a difference between two water levels is utilized to generate an electrical power, comprising:
a first water reservoir located at a high level;
a second water reservoir located at a low level;
an equipment for pumping water from said second low reservoir to said first high reservoir, the improvement comprising of: (a) a heat powered water pump positioned in said second reservoir for pumping water to said first reservoir, (b) a reverse penstock from said pump to said first reservoir, which has a non-return valve to allow water flow upstream but not downstream, and (c) a nuclear reactor with a heat conduit coupled directly to said water pump to provide said pump with thermal energy to operate said water pump and act as a prime mover for said heat-powered water pump;
a hydraulic turbine installed to receive water via penstock from said first reservoir and to discharge said water to said second reservoir and to convert said water's kinetic energy into mechanical energy of turbine rotation;
an electrical generator coupled to said turbine and rotated by said turbine to produce electrical energy.

2. A hybrid nuclear-hydro power plant according to claim 1, wherein said first and said second reservoirs are created by a dam in a river.

3. A hybrid nuclear-hydro power plant according to claim 1, wherein said first and said second reservoirs are created by a two man made or natural bodies of water of differing heights.

4. A hybrid nuclear-hydro power plant according to claim 1, wherein said reactor heat output may be proportionally diverted to pumping, desalination, or process heat loads to maintain the reactor core power level at a constant optimized steady state.

5. A heat-powered water lifting pump, the water pump energized according to claim 1, said pump having a plurality of components, the improvement comprising a pump with no moving mechanical parts to motivate the pumped water, no bladders, no rotating seals, or different chambers, with the exception of a set of non-return valves, one to prevent the entering water from re-exiting and another to prevent to exiting water from re-entering the pumping chamber.

6. A heat-powered water lifting pump, the water pump energized according to claim 1, said pump having a plurality of components, the improvement comprising a set of energy transfer devices defining a vaporizer assembly in which the high value heat from the nuclear reactor is transferred via radiation and conduction into the water creating steam to propel the water.

7. A heat-powered water lifting pump, the water pump energized according to claim 1, said pump having a common pressure vessel to house the vaporizer assembly and the pumping chamber, the improvement comprising the integration of the vapor generation and pumping chamber. This obviates the need for separate steam generators, bladders, conduits, and pumps.
